(19) United States
(12) Patent Application Publication
(10) Pub. No.: US 2011/0111977 A1
(43) Pub. Date: May 12, 2011

(54) HIGH THROUGHPUT SCREENING METHOD AND USE THEREOF TO IDENTIFY A PRODUCTION PLATFORM FOR A MULTIFUNCTIONAL BINDING PROTEIN

(75) Inventor: Diane Retallack, Poway, CA (US)

(73) Assignee: Pfenex, Inc., San Diego, CA (US)

(21) Appl. No.: 13/001,913

(22) PCT Filed: Jul. 1, 2009
(86) PCT No.: PCT/US09/49366

§ 371 Date: Dec. 29, 2010

Related U.S. Application Data
(60) Provisional application No. 61/078,292, filed on Jul. 3, 2008.

(51) Int. Cl. C40B 30/04

(52) U.S. Cl. 506/9

(57) ABSTRACT

Methods of identifying and expressing an antibody variant are disclosed wherein the method comprises identifying a binding region in an antibody, fusing the binding region to a plurality of scaffolds of antibody constant regions to obtain antibody fragment variants, expressing the antibody fragment variants in organisms to form constructs and expressing the constructs carried by the organisms to form induced cultures, wherein the organisms are expressed in HTP mode.

### CROSS REFERENCE TO RELATED APPLICATIONS

This application claims priority to U.S. Provisional Application No. 61/078,292, the disclosure of which is incorporated herein by reference in its entirety.

### FIELD OF THE INVENTION

This invention relates to methods of identifying and expressing antibody variants under high throughput conditions.

### BACKGROUND

High-throughput screening is a key link in the chain comprising the industrialized drug discovery paradigm. Today, many pharmaceutical companies are screening 100,000-300,000 or more compounds per screen to produce approximately 100-300 hits. On average, one or two of these become lead compound series. Larger screens of up to 1,000,000 compounds in several months may be required to generate something closer to five leads. Improvements in lead generation can also come from optimizing library diversity. Since the 1980s, improvements in screening technologies have resulted in throughputs that have increased from 10,000 assays per year to current levels, which can approach ultrahigh-throughput screening levels of more than 100,000 assays per day. High-throughput screening is evolving not only as a discrete activity, but also as a method that is being used for target identification and validation, and finds additional application in converting assay hits to qualified leads via information generated either within screens or through downstream, high-throughput ADME (absorption, distribution, metabolism, and excretion) and toxicity testing. High throughput screening has been used to identify and isolate antibodies, but only through binding of the antibodies to specific antigens, such as those present on a particular cell type, transformed or diseased cell, or a particular receptor or ligand. Identifying the best method to express an antibody variant once the binding region has been identified via phage display or other techniques can be challenging.

Current methods of antibody or antibody derivative discovery and development represent a significant bottleneck in the delivery of pharmacologically active molecules for clinical testing. Typically, mAB or Fab expression in E. coli, yeast, or CHO is attempted with a limited set of expression constructs. It would be useful to develop more efficient methods of matching antibody binding regions to antibody scaffold structures to find effective combinations of binding domains and scaffolds more rapidly.

### BRIEF SUMMARY OF THE INVENTION

Certain embodiments of the invention include methods of identifying and expressing a binding protein, wherein the method includes fusing a binding region to a plurality of scaffolds of antibody constant regions or other structural scaffolds to obtain an array of binding protein variants, expressing the variants in a host cell to form constructs, and expressing the constructs carried by the host cells to form induced cultures, wherein the host cells are expressed in high throughput (“HTP”) mode.

Other embodiments of the invention include a method of parallel screening for candidates by identifying fusing the plurality of binding regions to one or more scaffolds, in parallel, to obtain a plurality of variants, expressing the plurality of variants in, for example, Pseudomonas fluorescens to form constructs, expressing the construct carried by P. fluorescens to form induced cultures, and evaluating the induced cultures for product candidates. In certain embodiments, the binding region may be fused to the plurality of scaffolds by methods including Splicing by Overlapping Extension PCR(SOE-PCR), direct gene synthesis, and cloning of a binding region in frame with the scaffold structures present in pre-constructed vector sets

Another embodiment of the invention includes methods of developing binding protein product candidates by fusing a binding region of an antibody to a plurality of scaffolds in parallel to obtain variants, expressing the variants in, e.g., P fluorescens to form constructs, and expressing the constructs carried by the host cells to form induced cultures, wherein the cells are expressed in HTP mode.

In certain embodiments, the method includes starting with at least one known binding region that was identified by a screening method, and then fusing the at least one binding region to a multitude of scaffolds and screening the resulting variants.

Also described are methods of simultaneously identifying a structure able to bind at least one selected target and an expression plasmid or host cell therefor. Such a method includes fusing at least one binding domain, which binding domain interacts with a target of interest, to at least one molecule selected from the group consisting of at least one of a scaffold, another binding domain, and a functionalized domain; cloning the fused binding domain into a plurality of plasmids, each plasmid comprising various expression signals; transforming a host cell with the thus cloned plasmids; and simultaneously expressing transformants in the host cell in a high throughput manner and screening expressed fusions for antigen-binding activity so as to identify a structure able to bind the target of interest and expression plasmid or host cell therefor. The method can be repeated in one or more of its elements.

The molecule can be, among other things, a functionalized domain selected from the group consisting of a stability functionalized domain, a solubility functionalized domain, and a combination thereof. Alternatively, the molecule can be, among other things, a scaffold selected from the group consisting of an antibody constant region, a non-antibody natural or non-natural stabilizing structure, an additional binding domain derived from an antibody, and an additional non-antibody derived binding domain. The expression signals can be, among other things, selected from the group consisting of a transcription signal, a translation signal, a protein secretion signal, and any combination thereof.

The at least one binding domain can be, among other things, derived from an antibody-VH region, an antibody-VL region, a non-antibody binding protein of natural or non-natural origin, a fibronectin derivative, adnectin, ankyrin repeat protein, lipocalin, a protein A derivative, a gamma crystalline derivative, a transferrin derivative, and a synthetic peptide with immunoglobulin like folds. The binding domain preferably interacts with a particular target and is identified by a variety of sources comprising sources selected from the group consisting of a randomly generated library, screening B cells, screening T cells, screening sera, and combinations of any thereof. The interaction with a particular target can be identified by, among other things, bio-panning, panning, and/or display methods. The binding region can be fused to a scaffold by Splicing by Overlapping Extension PCR(SOE-PCR), gene synthesis, and cloning into pre-constructed vectors with scaffold coding region in correct translational reading frame.

An expression plasmid can include an inducible promoter, Ptac, or Pmannitol, a translation initiation site, a transcription terminator, and, optionally, a secretion signal. Transformation of an expression plasmid into the host cell can generate an array of production strains comprises expressing a variety of binding structures so as to simultaneously screen for titer and functionality in a high throughput in vivo or in vitro system. The host cell can be a bacterium, particularly a gram negative bacterium, such as pseudomonadaceaes, e.g., P. fluorescens. The bacterium can have one or more protease genes deleted.

The method can further comprise co-overexpressing folding modulators. In certain embodiments, the plasmids can express a single binding region fused to one or more scaffolds. In alternative embodiments, the plasmids can express more than one binding region fused to one or more scaffolds.

In particular embodiments, the hosts cells are grown and induced in a high throughput manner (e.g., using a multi-well well plate and/or growth of production strains in parallel). Such methods may include evaluating protein—protein interaction(s) by an in vitro and/or in vivo assay. The in vitro or in vivo assay can be an assay selected from the group consisting of ELISA, RIA, biolayer interferometry (such as Octet), surface plasmon resonance, two hybrid systems, cell based assay, and combinations thereof. In some embodiments, the method further includes screening activity in a high throughput manner.

Particular embodiments of the method further include simultaneously screening for a production host cell that expresses a high titer of fusion having a desired function or quality. The method may also further include activity testing of the fusion in an animal model. The method may further include identifying a candidate with a desired bioavailability, half-life, and/or reduced immunogenicity in a subject. In certain embodiments, the method further includes screening antibody derivatives. Alternative embodiments of the method further include screening libraries of non-natural binding proteins. In other embodiments, the method further includes screening derivatives of non-antibody binding proteins derived from naturally occurring proteins.

### BRIEF DESCRIPTION OF THE DRAWING

While the specification concludes with claims particularly pointing out and distinctly claiming that which is regarded as the present invention, this invention can be more readily understood and appreciated by one of ordinary skill in the art from the following description of the invention when read in conjunction with the accompanying drawings in which:

FIG. 1 is a graphical representation of histogram of optical density readings at 600 nm of HTP cultures taken 24 hours post induction;

FIG. 2 is a graphical representation of HTP expression of anti-β-galactosidase antibody derivatives;

FIG. 3 is a graphical representation of an antibody expression vector;

FIG. 4 is a graphical representation of anti-fluorescein antibody HTP expression; and

FIG. 5 is a graphical representation of product design for antibody derivative binding proteins.

### DETAILED DESCRIPTION OF THE INVENTION

Embodiments of the present invention provide methods of identifying and expressing an antibody variant that include identifying a binding region in an antibody, fusing the binding region to a plurality of scaffolds of antibody constant regions to obtain antibody fragment variants, expressing the antibody fragment variants in organisms to form constructs, and expressing the constructs carried by the organisms to form induced cultures, wherein the organisms are expressed in HTP mode.

The term “antibody” is used in the broadest sense and includes monoclonal antibodies, polyclonal antibodies, multivalent antibodies, multispecific antibodies (e.g., bispecific antibodies), and antibody fragments so long as they exhibit the desired biological activity. A naturally occurring antibody comprises four polypeptide chains, two identical heavy (H) chains and two identical light (L) chains inter-connected by disulfide bonds. Each heavy chain is comprised of a heavy chain variable region (VH) and a heavy chain constant region, which in its native form is comprised of three domains, CH1, CH2 and CH3. Each light chain is comprised of a light chain variable region (VL) and a light chain constant region. The light chain constant region is comprised of one domain, CL. The VH and VL regions can be further subdivided into regions of hypervariability, termed complementarity determining regions (CDR), interspersed with regions that are more conserved, termed framework regions (FR). Each VH and VL is composed of three CDRs and four FRs, arranged from amino-terminus to carboxy-terminus in the following order: FR1, CDR1, FR2, CDR2, FR3, CDR3, and FR4. The light chains of antibodies from any vertebrate species can be assigned to one of two clearly distinct types, called kappa (K) and lambda (A), based on the amino acid sequences of their constant domains. Depending on the amino acid sequences of the constant domains of their heavy chains, antibodies (immunoglobulins) can be assigned to different classes. There are five major classes of immunoglobulins: IgA, IgD, IgE, IgG and IgM, and several of these may be further divided into subclasses (isotypes), e.g., IgG-1, IgG-2, IgA-1, IgA-2, and etc. The heavy chain constant domains that correspond to the different classes of immunoglobulins are called α, β, ε, γ, and μ, respectively. The subunit structures and three-dimensional configurations of different classes of immunoglobulins are well known and described generally in, for example, Abbas et al. Cellular and Mol. Immunology, 4th ed. (2000). An antibody may be part of a larger fusion molecule, formed by covalent or noncovalent association of the antibody or antibody portion with one or more other proteins or peptides. Examples of such fusion proteins include use of the streptavidin core region to make a tetrameric scFv molecule (Kipriyanov et al. (1995) Human Antibodies and Hybridomas 6:93-101) and use of a cysteine residue, a marker peptide and a C-terminal polyhistidine tag to make bivalent and biotinylated scFv molecules (Kipriyanov, S. M., et al. (1994) Mol. Immulzol. 31:1047-1058).

The term “monoclonal antibody” as used herein refers to an antibody obtained from a population of substantially homogeneous antibodies, i.e., the individual antibodies comprising the population are identical except for possible naturally occurring mutations that may be present in minor amounts. Monoclonal antibodies are highly specific, being directed against a single antigen. Furthermore, in contrast to polyclonal antibody preparations that typically include different antibodies directed against different determinants (epitopes), each monoclonal antibody is directed against a single determinant on the antigen. The monoclonal antibodies herein specifically include “chimeric” antibodies in which a portion of the heavy and/or light chain is identical with or homologous to corresponding sequences in antibodies derived from a particular species or belonging to a particular antibody class or subclass, while the remainder of the chain(s) is identical with or homologous to corresponding sequences in antibodies derived from another species or belonging to another antibody class or subclass, as well as fragments of such antibodies, so long as they exhibit the desired biological activity (U.S. Pat. No. 4,816,567; and Morrison et al., Proc. Natl. Acad. Sci. USA 8 1:685 1-6855 (1984)).

A “functional” or “biologically active” antibody is one capable of exerting one or more of its natural activities in structural, regulatory, biochemical or biophysical events. For example, a functional antibody may have the ability to specifically bind an antigen and the binding may, in turn, elicit or alter a cellular or molecular event such as signaling transduction or enzymatic activity. A functional antibody may also block ligand activation of a receptor or act as an agonist antibody. The capability of an antibody to exert one or more of its natural activities depends on several factors, including proper folding and assembly of the polypeptide chains. As used herein, the functional antibodies generated by the disclosed methods are typically heterotetramers having two identical L chains and two identical H chains that are linked by multiple disulfide bonds and properly folded. In some aspects, embodiments of the present invention encompass blocking antibodies, antibody antagonists and/or antibody agonists. A “blocking” antibody or an antibody “antagonist” is one which inhibits or reduces biological activity of the antigen it binds. Such blocking can occur by any means, e.g., by interfering with: ligand binding to the receptor, receptor 10 complex formation, tyrosine kinase activity of a tyrosine kinase receptor in a receptor complex and/or phosphorylation of tyrosine kinase residue(s) in or by the receptor. For example, a VEGF antagonist antibody binds VEGF and inhibits the ability of VEGF to induce vascular endothelial cell proliferation. Preferred blocking antibodies or antagonist antibodies completely inhibit the biological activity of the antigen. An “antibody agonist” is an antibody which binds and activates antigen, such as a receptor. Generally, the receptor activation capability of the agonist antibody will be at least qualitatively similar (and may be essentially quantitatively similar) to a native agonist ligand of the receptor.

Embodiments of the present invention are applicable to antibodies or antibody fragments of any appropriate antigen binding specificity. The antibodies of the present invention may be specific to antigens that are biologically important polypeptides. Furthermore, the antibodies of the present invention may be useful for therapy or diagnosis of diseases or disorders in a mammal. The antibodies or antibody fragments obtained according to the embodiments of the present invention may be useful as therapeutic agents, such as blocking antibodies, antibody agonists or antibody conjugates. Non-limiting examples of therapeutic antibodies include anti-VEGF, anti-IgE, anti-CD 11, anti-CD 18, anti-tissue factor, and anti-TrkC antibodies. Antibodies directed against non-polypeptide antigens (such as tumor-associated glycolipid antigens) are also contemplated.

The term “antigen” is well understood in the art and includes substances which are immunogenic, i.e., immunogens, as well as substances which induce immunological unresponsiveness, or anergy, i.e., anergens. Where the antigen is a polypeptide, it may be a transmembrane molecule (e.g., receptor) or ligand such as a growth factor. Exemplary antigens include molecules, such as renin; a growth hormone, including human growth hormone and bovine growth hormone; growth hormone releasing factor; parathyroid hormone; thyroid stimulating hormone; lipoproteins; alpha-1-antitrypsin; insulin A-chain; insulin B-chain; proinsulin; follicle stimulating hormone; calcitonin; luteinizing hormone; glucagon; clotting factors, such as factor VIIIC, factor IX, tissue factor (TF), and von Willebrands factor; anti-clotting factors such as Protein C; atrial natriuretic factor; lung surfactant; a plasminogen activator, such as urokinase or human urine or tissue-type plasminogen activator (t-PA); bombesin; thrombin; hemopoietic growth factor; tumor necrosis factor-alpha and -beta; enkephalinase; RANTES (regulated on activation normally T-cell expressed and secreted); human macrophage inflammatory protein (MIP-1-alpha); a serum albumin such as human serum albumin; Muellerian-inhibiting substance; relaxin A-chain; relaxin B-chain; prorelaxin; mouse gonadotropin-associated peptide; a microbial protein, such as beta-lactamase; DNase; IgE; a cytotoxic T-lymphocyte associated antigen (CTLA), such as CTLA-4; inhibin; activin; vascular endothelial growth factor (VEGF); receptors for hormones or growth factors; protein A or D; rheumatoid factors; a neurotrophic factor such as bone-derived neurotrophic factor (BDNF), neurotrophin-3, -4, -5, or -6 (NT-3, NT-4, NT-5, or NT-6), or a nerve growth factor such as NGF-P; platelet derived growth factor (PDGF); fibroblast growth factor such as aFGF and bFGF; epidermal growth factor (EGF); transforming growth factor (TGF), such as TGF-alpha and TGF-beta, including TGF-βI, TGF-βP2, TGF-βP3, TGF-βP4, or TGF-βP5; insulin-like growth factor-I and -II (IGF-I and IGF-II); des(1-3)-IGF-I (brain IGF-I), insulin-like growth factor binding proteins; CD proteins, such as CD3, CD4, CD8, CD19 and CD20; erythropoietin; osteoinductive factors; immunotoxins; a bone morphogenetic protein (BMP); an interferon such as interferon-alpha, -beta, and -gamma; colony stimulating factors (CSFs), e.g., M-CSF, GM-CSF, and G-CSF; interleukins (ILs), e.g., IL-1 to IL-10; superoxide dismutase; T-cell receptors; surface membrane proteins; decay accelerating factor; viral antigen, such as, for example, a portion of the AIDS envelope; transport proteins; homing receptors; addressins; regulatory proteins; integrins, such as CD 11a, CD 11b, CD 11c, CD 18, an ICAM, VLA-4 and VCAM; a tumor associated antigen, such as HER2, HER3 or HER4 receptor; and fragments of any of the above-listed polypeptides.

Antigens for antibodies encompassed by embodiments of the present invention may include, for example: CD proteins, such as CD3, CD4, CD8, CD11a, CD11b, CD18, CD19, CD20, CD34 and CD46; members of the ErbB receptor family, such as the EGF receptor, HER2, HER3 or HER4 receptor; cell adhesion molecules, such as LFA-1, Mac 1, p150.95, VLA-4, ICAM-1, VCAM, α4/β7 integrin, and α av/β3 integrin including either α or β subunits thereof; growth factors, such as VEGF, tissue factor (TF), and TGF-β alpha interferon (α-IFN); an interleukin, such as IL-8; IgE; blood group antigens Apo2; death receptor; flk2/flt3 receptor; obesity (OB) receptor; mpl receptor; CTLA-4; and protein C.

Soluble antigens or fragments thereof, optionally conjugated to other molecules can be used as immunogens for generating antibodies. For transmembrane molecules, such as receptors, fragments of these molecules (e.g., the extracellular domain of a receptor) can be used as the immunogen. Alternatively, cells expressing the transmembrane molecule can be used as the immunogen. Such cells can be derived from a natural source (e.g., cancer cell lines) or may be cells which have been transformed by recombinant techniques to express the transmembrane molecule. Other antigens and forms thereof useful for preparing antibodies will be apparent to those in the art. The antibodies according to embodiments of the present invention may be monospecific, bispecific, trispecific or of greater multispecificity. Multispecific antibodies may be specific to different epitopes of a single molecule or may be specific to epitopes on different molecules. Methods for designing and making multispecific antibodies are known in the art. See, e.g., Millstein et al. (1983) Nature 305:537-539; Kostelny et al. (1992) J. Immunol. 148: 1547-1553; WO 20 93117715.

Embodiments of the present invention contemplate the prokaryotic or eukaryotic production of antibodies or antibody fragments. Many forms of antibody fragments are known in the art and encompassed herein. “Antibody fragments” comprise only a portion of an intact antibody, generally including an antigen binding site of the intact antibody and thus retaining the ability to bind antigen. Examples of antibody fragments encompassed by the present definition include: (i) the Fab fragment, having VL, CL, VH and CH1 domains; (ii) the Fab′ fragment, which is a Fab fragment having one or more cysteine residues at the C-terminus of the CH1 domain; (iii) the Fd fragment having VH and CH1 domains; (iv) the Fd′ fragment having VH and CH1 domains and one or more cysteine residues at the C-terminus of the CH1 domain; (v) the Fv fragment having the VL and VH domains of a single arm of an antibody; (vi) the dAb fragment (Ward et al., Nature 341, 544-546 (1989)) which consists of a VH domain; (vii) isolated CDR regions; (viii) F(ab′)₂ fragments, a bivalent fragment including two Fab′ fragments linked by a disulfide bridge at the hinge region; (ix) single chain antibody molecules (e.g., single chain Fv; scFv) (Bird et al., Science 242:423-426 (1988); and Huston et al., PNAS (USA) 85:5879-5883 (1988)); (x) “diabodies” with two antigen binding sites, comprising a heavy chain variable domain (VH) connected to a light chain variable domain (VL) in the same polypeptide chain (see, e.g., EP 404,097; WO 93/11161; and Hollinger et al., Proc. Natl. Acad. Sci. USA, 90:6444-6448 (1993)); (xi) “linear antibodies” comprising a pair of tandem Fd segments (VH-CH1-VH-CH1) which, together with complementary light chain polypeptides, form a pair of antigen binding regions (Zapata et al. Proteifz Eng. 8(10): 1057-1062 (1995); and U.S. Pat. No. 5,641,870).

Moreover, embodiments of the present invention may include antibody fragments that are modified to improve their stability and or to create antibody complexes with multivalency. For many medical applications, antibody fragments must be sufficiently stable against denaturation or proteolysis conditions, and the antibody fragments should ideally bind the target antigens with high affinity. A variety of techniques and materials have been developed to provide stabilized and or multivalent antibody fragments. An antibody fragment may be fused to a dimerization domain. In one embodiment, the antibody fragments of the present invention are dimerized by the attachment of a dimerization domain, such as leucine zippers.

“Leucine zipper” is a protein dimerization motif found in many eukaryotic transcription factors where it serves to bring two DNA-binding domains into appropriate juxtaposition for binding to transcriptional enhancer sequences. Dimerization of leucine zippers occurs via the formation of a short parallel coiled coil, with a pair of α-helices wrapped around each other in a superhelical twist. Zhu et al. (2000) J. Mol. Biol. 25 300: 1377-1387. These coiled-coil structures, named “leucine zippers” because of their preference for leucine in every 7th position, have also been used as dimerization devices in other proteins including antibodies. Hu et al. (1990) Science 250: 1400-1403; Blondel and Bedouelle (1991) Protein Eng. 4:457. Several species of leucine zippers have been identified as particularly useful for dimeric and tetrameric antibody constructs. Pluckthun and Pack (1997) Immunotech. 3:83-105; Kostelny et al. (1992) J. Immunol. 148:1 547-1 553.

Embodiments of the present invention may include amino acid sequence modification(s) of antibodies or fragments thereof. For example, it may be desirable to improve the binding affinity and/or other biological properties of the antibody. Amino acid sequence variants of the antibody are prepared by introducing appropriate nucleotide changes into the antibody nucleic acid, or by peptide synthesis. Such modifications include, for example, deletions from, and/or insertions into and/or substitutions of, residues within the amino acid sequences of the antibody. Any combination of deletion, insertion, and substitution is made to arrive at the final construct, provided that the final construct possesses the desired characteristics. The amino acid alterations may be introduced in the subject antibody amino acid sequence at the time that sequence is made.

A useful method for identification of certain residues or regions of the antibody that are preferred locations for mutagenesis is called “alanine scanning mutagenesis” as described by Cunningham and Wells (1989) Science, 244: 108 1-1085. Here, a residue or group of target residues is identified (e.g., charged residues such as Arg, Asp, His, Lys, and Glu) and replaced by a neutral or negatively charged amino acid (for example alanine or polyalanine) to affect the interaction of the amino acids with antigen. Those amino acid locations demonstrating functional sensitivity to the substitutions may then be refined by introducing further or other variants at, or for, the sites of substitution. Thus, while the site for introducing an amino acid sequence variation is predetermined, the nature of the mutation per se need not be predetermined. For example, to analyze the performance of a mutation at a given site, ala scanning or random mutagenesis is conducted at the target codon or region and the expressed antibodies are screened for the desired activity. Amino acid sequence insertions include amino- and/or carboxyl-terminal fusions ranging in length from one residue to polypeptides containing a hundred or more residues, as well as intrasequence insertions of single or multiple amino acid residues. Non-limiting examples of terminal insertions include an antibody with an N-terminal methionyl residue or the antibody fused to a cytotoxic polypeptide. Other insertional variants of the antibody molecule include the fusion to the N- or C-terminus of the antibody to an enzyme (e.g., for ADEPT) or a polypeptide which increases the serum half-life of the antibody. Another type of variant is an amino acid substitution variant. These variants have at least one amino acid residue in the antibody molecule replaced by a different residue. The sites of greatest interest for substitutional mutagenesis include the hypervariable regions, but FR alterations are also contemplated.

Substantial modifications in the biological properties of the antibody are accomplished by selecting substitutions that differ significantly in their effect on maintaining: (a) the structure of the polypeptide backbone in the area of the substitution, for example, as a sheet or helical conformation, (b) the charge or hydrophobicity of the molecule at the target site, or (c) the bulk of the side chain. Naturally occurring residues are divided into groups based on common side-chain properties:

(1) hydrophobic: norleucine, Met, Ala, Val, Leu, Ile;

(2) neutral hydrophilic: Cys, Ser, Thr;

(3) acidic: Asp, Glu;

(4) basic: Asn, Gln, His, Lys, Arg;

(5) residues that influence chain orientation: Gly, Pro; and

(6) aromatic: Trp, Tyr, Phe.

Non-conservative substitutions may entail exchanging a member of one of these classes for another class.

Any cysteine residue not involved in maintaining the proper conformation of the antibody may be substituted, generally with serine, to improve the oxidative stability of the molecule and prevent aberrant crosslinking. Conversely, cysteine bond(s) may be added to the antibody to improve its stability. A particular type of substitutional variant involves substituting one or more hypervariable region residues of a parent antibody (e.g., a humanized or human antibody). Generally, the resulting variant(s) selected for further development will have improved biological properties relative to the parent antibody from which they are generated. A convenient way for generating such substitutional variants involves affinity maturation using phage display. Briefly, several hypervariable region sites (e.g., 6-7 sites) are mutated to generate all possible amino acid substitutions at each site. The antibodies thus generated are displayed from filamentous phage particles as fusions to the gene III product of M13 packaged within each particle. The phage-displayed variants are then screened for their biological activity (e.g., binding affinity) as herein disclosed. In order to identify candidate hypervariable region sites for modification, alanine scanning mutagenesis can be performed to identify hypervariable region residues contributing significantly to antigen binding. Alternatively, or additionally, it may be beneficial to analyze a crystal structure of the antigen-antibody complex to identify contact points between the antibody and antigen. Such contact residues and neighboring residues are candidates for substitution according to the techniques elaborated herein. Once such variants are generated, the panel of variants is subjected to screening as described herein and antibodies with superior properties in one or more relevant assays may be selected for further development.

Nucleic acid molecules encoding amino acid sequence variants of the antibody are prepared by a variety of methods known in the art. These methods include, but are not limited to, isolation from a natural source (in the case of naturally occurring amino acid sequence variants) or preparation by oligonucleotide-mediated (or site-directed) mutagenesis, PCR mutagenesis, and cassette mutagenesis of an earlier prepared variant or a non-variant version of the antibody.

It may be desirable to introduce one or more amino acid modifications in an Fc region of the antibody of the invention, thereby generating a Fc region variant. The Fc region variant may comprise a human Fc region sequence (e.g., a human IgG1, IgG2, IgG3 or IgG4 Fc region) comprising an amino acid modification (e.g., a substitution) at one or more amino acid positions.

In one embodiment, the Fc region variant may display altered neonatal Fc receptor (FcRn) binding affinity. Such variant Fc regions may comprise an amino acid modification at any one or more of amino acid positions 238, 252, 253, 254, 255, 256, 265, 272, 286, 288, 303, 305, 307, 309, 311, 312, 317, 340, 356, 360, 362, 376, 378, 380, 382, 386, 388, 400, 413, 415, 424, 433, 434, 435, 436, 439 or 447 of the Fc region, wherein the numbering of the residues in the Fc region is that of the EU index as in Kabat. Fc region variants with reduced binding to an FcRn may comprise an amino acid modification at any one or more of amino acid positions 252, 253, 254, 255, 288, 309, 386, 388, 400, 415, 433, 435, 436, 439 or 447 of the Fc region, wherein the numbering of the residues in the Fc region is that of the EU index as in Kabat. The above-mentioned Fc region variants may, alternatively, display increased binding to FcRn and comprise an amino acid modification at any one or more of amino acid positions 238, 256, 265, 272, 286, 303, 305, 307, 311, 312, 317, 340, 356, 360, 362, 376, 378, 380, 382, 413, 424 or 434 of the Fc region, wherein the numbering of the residues in the Fc region is that of the EU index as in Kabat. The Fc region variant with reduced binding to an FcyR may comprise an amino acid modification at any one or more of amino acid positions 238, 239, 248, 249, 252, 254, 265, 268, 269, 270, 272, 278, 289, 292, 293, 294, 295, 296, 298, 301, 303, 322, 324, 327, 329, 333, 335, 338, 340, 373, 376, 382, 388, 389, 414, 416, 419, 434, 435, 437, 438 or 439 of the Fc region, wherein the numbering of the residues in the Fc region is that of the EU index as in Kabat. For example, the Fc region variant may display reduced binding to an FcγRI and comprise an amino acid modification at any one or more of amino acid positions 238, 265, 269, 270, 327 or 329 of the Fc region, wherein the numbering of the residues in the Fc region is that of the EU index as in Kabat. The Fc region variant may display reduced binding to an FcγRII and comprise an amino acid modification at any one or more of amino acid positions 238, 265, 269, 270, 292, 294, 295, 298, 303, 324, 327, 329, 333, 335, 338, 373, 376, 414, 416, 419, 435, 438 or 439 of the Fc region, wherein the numbering of the residues in the Fc region is that of the EU index as in Kabat. The Fc region variant of interest may display reduced binding to an FcγRIII and comprise an amino acid modification at one or more of amino acid positions 238, 239, 248, 249, 252, 254, 265, 268, 269, 270, 272, 278, 289, 293, 294, 295, 296, 301, 303, 322, 327, 329, 338, 340, 373, 376, 382, 388, 389, 416, 434, 435 or 437 of the Fc region, wherein the numbering of the residues in the Fc region is that of the EU index as in Kabat.

Fc region variants with altered (i.e. improved or diminished) C1q binding and/or Complement Dependent Cytotoxicity (CDC) are described in WO99/51642. Such variants may comprise an amino acid substitution at one or more of amino acid positions 270, 322, 326, 327, 329, 331, 333 or 334 of the Fc region. See, also, Duncan & Winter Nature 322:738-40 (1988); U.S. Pat. No. 5,648,260; U.S. Pat. No. 5,624,821; and WO94129351 concerning Fc region variants.

The antibodies and antibody variants may be further modified to contain additional non-proteinaceous moieties that are known in the art and readily available. Derivatizations are especially useful for improving or restoring biological properties of the antibody or fragments thereof. For example, PEG modification of antibody fragments can alter the stability, in vivo circulating half life, binding affinity, solubility and resistance to proteolysis. The moieties suitable for derivatization of the antibody may be are water soluble polymers. Non-limiting examples of water soluble polymers may include, but are not limited to, polyethylene glycol (PEG), copolymers of ethylene glycol/propylene glycol, carboxymethylcellulose, dextran, polyvinyl alcohol, polyvinyl pyrrolidone, poly-1,3-dioxolane, poly-1,3,6-trioxane, ethylene/maleic anhydride copolymer, polyamino acids (either homopolymers or random copolymers), and dextran or poly(n-vinyl pyrrolidone)polyethylene glycol, propropylene glycol homopolymers, polypropylene oxide/ethylene oxide co-polymers, polyoxyethylated polyols (e.g., glycerol), polyvinyl alcohol, and mixtures thereof. Polyethylene glycol propionaldehyde may have advantages in manufacturing due to its stability in water. The polymer may be of any molecular weight, and may be branched or unbranched. The number of polymers attached to the antibody may vary, and if more than one polymer is attached, they may be the same or different molecules. In general, the number and or type of polymers used for derivatization may be determined based on considerations including, but not limited to, the particular properties or functions of the antibody to be improved, whether the antibody derivative will be used in a therapy under defined conditions.

In general, the antibody or antibody fragment produced by a prokaryotic expression system as described herein may be aglycosylated and may lack detectable effector activities of the Fc region. In some instances, it may be desirable to at least partially restore one or more effector functions of the native antibody. Accordingly, embodiments of the present invention contemplate a method for restoring the effector function(s) by attaching suitable moieties to identified residue sites in the Fc region of an aglycosylated antibody. For example, one moiety for this purpose may be PEG, although other carbohydrate polymers may also be used. PEGylation may be carried out by any of the PEGylation reactions known in the art. See, for example, EP 0401384; EP 0154316; WO 98148837. In one embodiment, cysteine residues are first substituted for residues at identified positions of the antibody, such as those positions wherein the antibody or antibody variant is normally glycosylated or those positions on the surface of the antibody. For example, the cysteine may be substituted for residue(s) at one or more positions 297, 298, 299, 264, 265 and 239 (numbering according to the EU index as in Kabat). After expression, the cysteine substituted antibody variant may have various forms of PEG (or pre-synthesized carbohydrate) chemically linked to the free cysteine residues.

The term “binding region”, as used herein, need not be derived from an antibody or antibody fragment. Other natural (e.g., fibronectin, protein A derivatives) and non-natural (e.g., synthetic immunoglobulin folds, etc.) protein fragments/domains could be used as well. The term binding region can be singular or plural.

As used herein, the term “identifying a binding region” or “identifying a plurality of binding regions” refers to a plurality of antibodies and proteins comprising a plurality of unique immunoglobulins or antibody chains (e.g., heavy or light chains) (or other non-antibody binding proteins). In embodiments of the current invention, antibody or protein libraries comprise between about 10⁶ to about 10¹¹ or even more unique antibodies or antibody chains or proteins. High Throughput Production of Antibodies and Proteins Antibodies and protein combinations for hundreds of proteins can be tested in parallel using protein arrays and antibody or protein libraries. Briefly, thousands of different proteins are produced using high throughput techniques and displayed in a multiwell format (e.g., 96 to 1536 wells). The antigens thus displayed are exposed to antibody libraries for extended periods of time, typically two to twenty-four hours, as necessary for binding at one or more affinities. This allows each antibody in the library to bind the antigen to which it has highest affinity. Bound antibodies and proteins are identified using one of a variety of approaches. For example, when using a phage display method antibodies or proteins are expressed in phage as fusions with a phage surface protein, resulting in the antibodies or proteins being displayed on the surface of the phage. A library of phage expressing different binding moieties is produced and bound to immobilized, target proteins in high throughput fashion. Phage with high affinity for target proteins are then isolated. Serial passages may be necessary to enrich for antibodies and proteins of interest. To do this the selected phage from one round are re-grown in bacteria, the new enriched phage culture is harvested, bound again to immobilized target proteins and the newly selected phage are re-isolated. The isolated phage can be amplified for further testing and the sequence of the binding region determined. Other methods known in the art for displaying antibodies or proteins may also be used in addition to phage display. Several types of antibody or protein libraries may be used for screening, including single chain, phage display, and potentially a two chain antibody library generated through a strategy described below. Humanized antibodies and proteins may be used so that they can be used for therapeutic purposes. Antibody and protein libraries are commercially available from a number of sources. Binding regions may be identified via alternative methods as known in the art. For example, binding sites may be identified via ribosome display, yeast display, bacterial display, and mRNA display.

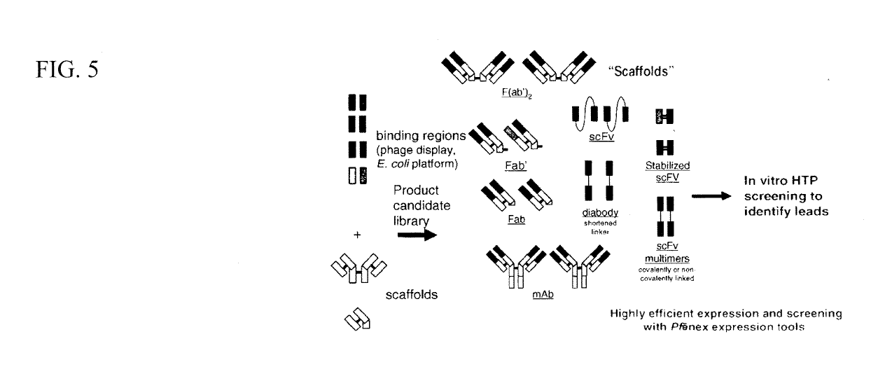

As used herein, the term “fusing the binding region to a plurality of scaffolds of antibody constant regions” refers to fusion of one or more binding regions (antibody light and heavy chain variable regions, or other natural or non-natural binding domain) or fused to scaffolds other than antibody constant regions to scaffolds of antibody constant regions as seen in FIG. 5. Fusion of antibody binding regions to scaffolds of antibody constant regions may be achieved by, for example, SOE-PCR, direct gene synthesis, or cloning of binding regions in frame with scaffold structures present in pre-constructed vectors. After an antibody binding region is fused to scaffolds of antibody constant regions an antibody fragment variant may be obtained. As a non-limiting example, these antibody fragment variants or “scaffolds” may include F(ab′)₂, Fab′, Fab, mAb, diabody, scFv, stabilized scFv, or scFv multimers. While previous methods included comparisons of limited number of host strains or regulatory elements in more or less sequential fashion, embodiments according to the present invention show that multiple scaffolds for the same binding domain may be fused to that binding domain and rapidly screened to identify good producers that can be scaled up and tested for efficacy. Alternatively, a single molecule may be screened rapidly in hundreds of host strains in parallel to identify the optimal production strain.

By “protein” herein is meant at least two amino acids linked together by a peptide bond. As used herein, protein includes proteins, oligopeptides and peptides. The peptidyl group may comprise naturally occurring amino acids and peptide bonds, or synthetic peptidomimetic structures, i.e. “analogs”, such as peptoids (see Simon et al., PNAS USA 89(20):9367 (1992)). The amino acids may either be naturally occurring or non-naturally occurring; as will be appreciated by those in the art, any structure for which a set of rotamers is known or can be generated can be used as an amino acid. The side chains may be in either the (R) or the (S) configuration. In an embodiment, the amino acids are in the (S) or L-configuration.

The scaffold protein may be any protein for which a three dimensional structure is known or can be generated; that is, for which there are three dimensional coordinates for each atom of the protein. Generally, this can be determined using X-ray crystallographic techniques, NMR techniques, de novo modeling, homology modeling, etc. In general, if X-ray structures are used, structures may be, for example, at 2 Å resolution.

The scaffold proteins may be from any organism, including prokaryotes and eukaryotes, with enzymes from bacteria, fungi, extremeophiles such as the archebacteria, insects, fish, animals (for example mammals or human) and birds all possible.

Thus, by “scaffold protein” herein is meant a protein for which a library of variants may exist. As will be appreciated by those in the art, any number of scaffold proteins find use in the embodiments of the present invention. Specifically included within the definition of “protein” are fragments and domains of known proteins or antibodies, including functional domains such as enzymatic domains, binding domains, etc., and smaller fragments, such as turns, loops, etc. That is, portions of proteins may be used as well. In addition, “protein” as used herein includes proteins, oligopeptides and peptides. In addition, protein variants, i.e. non-naturally occurring protein analog structures, may be used.

Suitable proteins include, but are not limited to, industrial and pharmaceutical proteins, including ligands, cell surface receptors, antigens, antibodies, cytokines, hormones, transcription factors, signaling modules, cytoskeletal proteins and enzymes. Suitable classes of enzymes include, but are not limited to, hydrolases such as proteases, carbohydrases, lipases; isomerases such as racemases, epimerases, tautomerases, or mutases; transferases, kinases, oxidoreductases, and phosphatases. Suitable enzymes are listed in the Swiss-Prot enzyme database. Suitable protein backbones include, but are not limited to, all of those found in the protein data base compiled and serviced by the Research Collaboratory for Structural Bioinformatics (RCSB, formerly the Brookhaven National Lab).

Specifically, scaffold proteins may include, but are not limited to, those with known structures (including variants) including cytokines (IL-1ra (+receptor complex), IL-1 (receptor alone), IL-1a, IL-1b (including variants and or receptor complex), IL-2, IL-3, IL-4, IL-5, IL6, IL-8, IL-10, IFN-β, INF-γ, IFN-α-2a; IFN-α-2B, TNF-α; CD40 ligand (chk), Human Obesity Protein Leptin, Granulocyte-Macrophage Colony-Stimulating Factor, Bone Morphogenetic Protein-7, Ciliary Neurotrophic Factor, Granulocyte-Macrophage Colony-Stimulating Factor, Monocyte Chemoattractant Protein 1, Macrophage Migration Inhibitory Factor, Human Glycosylation-Inhibiting Factor, Human Rantes, Human Macrophage Inflammatory Protein 1 Beta, human growth hormone, Leukemia Inhibitory Factor, Human Melanoma Growth Stimulatory Activity, neutrophil activating peptide-2, Cc-Chemokine Mcp-3, Platelet Factor M2, Neutrophil Activating Peptide 2, Eotaxin, Stromal Cell-Derived Factor-1, Insulin, Insulin-like Growth Factor I, Insulin-like Growth Factor II, Transforming Growth Factor B1, Transforming Growth Factor B2, Transforming Growth Factor B3, Transforming Growth Factor A, Vascular Endothelial growth factor (VEGF), acidic Fibroblast growth factor, basic Fibroblast growth factor, Endothelial growth factor, Nerve growth factor, Brain Derived Neurotrophic Factor, Ciliary Neurotrophic Factor, Platelet Derived Growth Factor, Human Hepatocyte Growth Factor, Glial Cell-Derived Neurotrophic Factor, (as well as the 55 cytokines in PDB Jan. 12, 1999. Erythropoietin; other extracellular signaling moieties, including, but not limited to, hedgehog Sonic, hedgehog Desert, hedgehog Indian, hCG; coagulation factors including, but not limited to, TPA and Factor VIIa; transcription factors, including but not limited to, p53, p53 tetramerization domain, Zn fingers (of which more than 12 have structures), homeodomains (of which 8 have structures), leucine zippers (of which 4 have structures); antibodies, including, but not limited to, cFv; viral proteins, including, but not limited to, hemagglutinin trimerization domain and HIV Gp41 ectodomain (fusion domain); intracellular signaling modules, including, but not limited to, SH2 domains (of which 8 structures are known), SH3 domains (of which 11 have structures), and Pleckstin Homology Domains; receptors, including, but not limited to, the extracellular Region Of Human Tissue Factor Cytokine-Binding Region Of Gp130, G-CSF receptor, erythropoietin receptor, Fibroblast Growth Factor receptor, TNF receptor, IL-1 receptor, IL-1 receptor/IL1ra complex, IL4 receptor, INF-γ receptor alpha chain, MHC Class I, MHC Class II, T Cell Receptor, Insulin receptor, insulin receptor tyrosine kinase and human growth hormone receptor.

The antibody fragment variants according to the embodiments of the present invention may be expressed in a host cell or host organism, i.e. for expression and/or production of a construct. Suitable hosts or host cells will be clear to the skilled person, and may for example be any suitable fungal, prokaryotic or eukaryotic cell or cell line or any suitable fungal, prokaryotic or eukaryotic organism, for example: a bacterial strain, including but not limited to gram-negative strains such as strains of Escherichia coli; of Proteus, for example of Proteus mirabilis; of Pseudomonas, for example of Pseudomonas fluorescens; and gram-positive strains such as strains of Bacillus, for example of Bacillus subtilis or of Bacillus brevis; of Streptomyces, for example of Streptomyces lividans; of Staphylococcus, for example of Staphylococcus carnosus; and of Lactococcus, for example of Lactococcus lactis; a fungal cell, including but not limited to cells from species of Trichoderma, for example from Trichoderma reesei; of Neurospora, for example from Neurospora crassa; of Sordaria, for example from Sordaria macrospora; of Aspergillus, for example from Aspergillus niger or from Aspergillus sojae; or from other filamentous fungi; a yeast cell, including but not limited to cells from species of Saccharomyces, for example of Saccharomyces cerevisiae; of Schizosaccharomyces, for example of Schizosaccharomyces pombe; of Pichia, for example of Pichia pastoris or of Pichia methanolica; of Hansenula, for example of Hansenula polymorpha; of Kluyveromyces, for example of Kluyveromyces lactis; of Arxula, for example of Arxula adeninivorans; of Yarrowia, for example of Yarrowia lipolytica; an amphibian cell or cell line, such as Xenopus oocytes; an insect-derived cell or cell line, such as cells/cell lines derived from lepidoptera, including but not limited to Spodoptera SF9 and Sf21 cells or cells/cell lines derived from Drosophila, such as Schneider and Kc cells; a plant or plant cell, for example in tobacco plants; and/or a mammalian cell or cell line, for example derived a cell or cell line derived from a human, from the mammals including but not limited to CHO-cells, BHK-cells (for example BHK-21 cells) and human cells or cell lines such as HeLa, COS (for example COS-7) and PER.C6 cells; as well as all other hosts or host cells known per se for the expression and production of antibodies and antibody fragments (including but not limited to (single) domain antibodies and ScFv fragments), which will be clear to the skilled person. Reference is also made to the general background art cited hereinabove, as well as to, for example, WO 94/29457; WO 96/34103; WO 99/42077; Frenken et al., (1998), supra; Riechmann and Muyldermans, (1999), supra; van der Linden, (2000), supra; Thomassen et al., (2002), supra; Joosten et al., (2003), supra; Joosten et al., (2005), supra; and the further references cited herein.

Expression of the antibody fragment variant to form constructs may be achieved by utilizing, for example, PFENEX EXPRESSION TECHNOLOGY™, which is a Pseudomonas fluorescens-based expression system that increases cellular expression while maintaining certain solubility and activity characteristics due to its use of different pathways in the metabolism of certain sugars compared to E. coli. Expression of mammalian proteins via a Pseudomonas based expression system is described, for instance, in US Patent Application 20060234346 and US Patent Application 20060040352, the contents of which are hereby incorporated by reference. Antibody fragment variants may be expressed in Pseudomonas fluorescens utilizing PFENEX EXPRESSION TECHNOLOGY™ components such as, for example, multiple promoter secretion signals, ribosome binding sites, protease knockout hosts, transcriptional/translational regulatory protein knockout or overexpression hosts, and folding modulator overexpression hosts.

For production on industrial scale, preferred heterologous hosts for the (industrial) production of constructs of the invention include strains of E. coli, Pichia pastoris, S. cerevisiae or P. fluorescens that are suitable for large scale expression/production/fermentation, and in particular for large scale pharmaceutical expression/production/fermentation. Suitable examples of such strains will be clear to the skilled person. Such strains and production/expression systems are also made available by companies such as Dowpharma and Biovitrum (Uppsala, Sweden).

Induced cultures may be formed by expressing the previously formed construct carried by the organism or cell, for example P. fluorescens, in high throughput (HTP) mode. The induced cultures may be evaluated for both binding strength and protein yield by utilizing ELISA based tests, biolayer interferometry, or similar methods. Thereby, optimal product candidates and production strains may be identified in a single screen. Utilizing the embodiments of the present invention, multiple fragment types of a single binding region may be identified and screened in animal models to evaluate the fragment type that provides optimal bioavailability, half life, and reduced immunogenicity. Additionally, multiple binding regions fused to one or more scaffolds, or constructed as scFvs, diabodies, or similar constructs, may be screened in a similar fashion.

A protein's functionality depends upon complex, subtle, and sensitive interactions among all of its parts. Thus, a single amino acid change made in a protein of any size may seriously or completely disrupt its folding and activity. Methods currently employed to discover and then further develop antibody binding domains into biologically and pharmacologically active compounds suffer from this disruptive gap. They are severely limited by the fact that the steps between discovery and development reside in two different protein structural platforms resulting in a disconnect between the functionality of the binding domain in the discovery platform versus the functionality of the binding domain in the development platform. Embodiments of the present invention may narrow the disconnection between the platforms by building many more degrees of freedom into the development process, allowing many more combinations of functional molecules to be tested in parallel. Therefore, a more rapid development of robust binding molecules for functional and pre-clinical testing may be achieved.

The present invention is further described in the following examples, which are offered by way of illustration and are not intended to limit the invention in any manner.

### EXAMPLES

### Example 1

### Expression Strains and Plasmids

Strains used for anti-β-galactosidase derivative expression are shown in Table 1. For each antibody fragment expressed, the VH and VL regions of the Gal2 and Gal13 scFvs identified by Martineau et al. (2, 3) were fused to the appropriate constant regions of human IgG1 (portions of CH1CH2CH3 and Cκ respectively) to generate FAb or mAb molecules. For the Gal13 diabody, the linker between the VH and VL domains was reduced from three to one Gly₄Ser clusters.

Genes encoding the heavy and light chains of anti-fluorescein antibody separated by a bi-directional terminator and cloned into and expressed from a library of 74 expression vectors. The vectors contain various combinations of the Ptac and Pmtl promoters, 3 ribosome binding sites of varying strengths (high, medium and low) and three P. fluorescens secretion leaders (pbp, azurin and iron binding protein).

TABLE 1
Strains used in the anti-β-galactosidase expression study

| Strain | Fragment | Binding Region |
|---|---|---|
| DC351 | scFv | Gal2 |
| DC536 | truncated Fab | Gal2 |
| DC589 | Fab | Gal2 |
| DC478 | mAb | Gal2 |
| DC698 | scFv | Gal13 |
| DC694 | diabody | Gal13 |
| DC699 | Fab | Gal13 |
| DC608 | mAB | Gal13 |

### Example 2

### Growth and Expression in 96-Well Plates

Seed cultures were grown in 96-well deep well plate with salts 1% glucose media and incubated at 30° C., shaking for 48 hours. Ten microliters of seed culture were transferred into triplicate 96-well deep well plates, each well containing 500 μl of HTP medium, and incubated, as before, for 24 hours. Isopropyl-β-D-1-thiogalactopyranoside (IPTG) was added to each well for a final concentration of 0.3 mM, as well as 1% mannitol in some cases, to induce the expression of the heavy and light chain proteins and temperature was reduced to 25° C. After 24 hours of protein induction, cells were normalized to OD₆₀₀=20 in a volume of 200 μl, in duplicate, using the Biomek (Becton Coulter) in cluster tube racks.

### Example 3

### Sample Preparation

Samples were prepared for analysis by sonicating strain array cultures (cells normalized to OD₆₀₀=20 in a volume of 200 μl) for 10 minutes using a non-contact cup horn sonicator (Branson Ultrasonics). The sonicates were centrifuged in a swinging bucket centrifuge (model CR422, Jouan, Inc., Winchester, Va.) at 2000×g for 35 minutes at 4° C. and the supernatants removed (soluble fraction) and stored at −20C until further analysis.

### Example 4

### β-Galactosidase Binding Assay

Streptavidin High Binding biosensors (ForteBio # 18-0006) were hydrated in kinetics buffer (ForteBio), then loaded with 10 μg/mL biotin-β-galactosidase (Sigma #G5025 lot #034K6020) for 2 hours, rinsed in kinetics buffer a few minutes, then pre-equilibrated in 25% DC432 soluble fraction for 25 minutes before starting assay.

The standards (mAb anti-β-galactosidase, Sigma #G8021; purified Gal13 scFv; purified Gal13 diabody) were diluted into 25% empty vector control soluble fraction. The test samples were diluted 2-fold into kinetics buffer (PBS/0.01% BSA/0.001% Tween). The samples were pre-equilibrated at 30° C. for 10 minutes, and the assay was started. Samples were read at 30° C. for 180 seconds with a mixing rate of 1000 rpm.

### Example 5

### Fluorescein Binding Assay

Streptavidin High Binding biosensors (ForteBio # 18-0006) were hydrated in kinetics buffer (ForteBio), then loaded with 4 ug/mL biotinylated ligand (5(6)-(biotinamidohexanoyl-amido)pentylthioureidyl-fluorescein, Sigma cat# B8889-1MG) diluted into 1×kinetics buffer for 30 minutes. The test samples were diluted 2-fold into kinetics buffer (PBS/0.01% BSA/0.001% Tween). The samples were pre-equilibrated at 30° C. for 10 minutes, and the assay was started. Samples were read at 30° C. for 180 seconds with a mixing rate of 1000 rpm. Qunatitation was performed in comparison with a standard (anti-fluorescein/Oregon green mouse IgG monoclonal 4-4-20, Invitrogen (Molecular Probes, Eugene, Oreg., US) cat# A6421)

### Example 6

### Expression of Anti-β-Galactosidase Antibody Derivatives

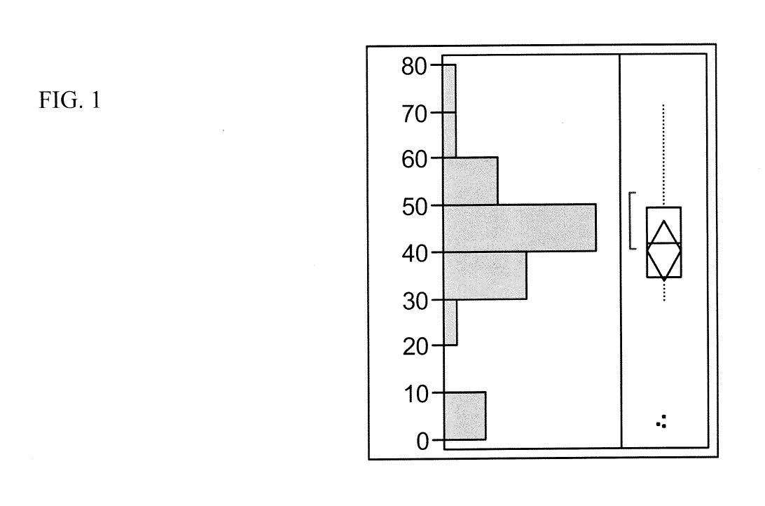

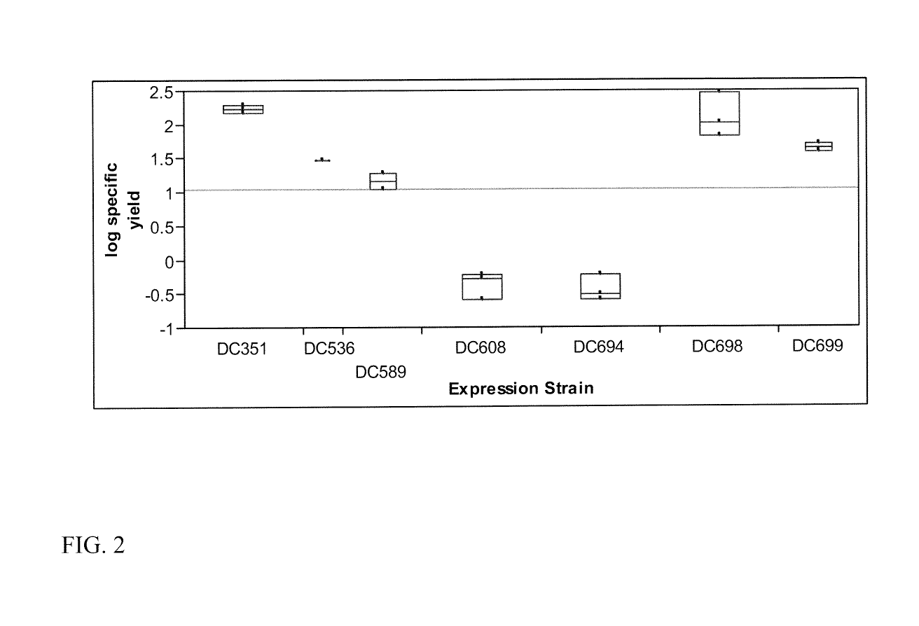

The variable domains of the Gal2 and Gal13 scFvs (1-3) were fused to human IgG1 constant regions to produce a monoclonal antibody and antibody fragment derivatives, as well as fused directly with a linker of 4 glycine and one serine to produce a diabody as seen in FIG. 1 Additionally, FIG. 1 shows a histogram of optical density readings at 600 nm of cultures taken 24 hours post induction. Expression of each protein was directed to the periplasmic space via the phosphate binding protein secretion leader (4). A total of 4 antibody derivatives were constructed for each (3-galactosidase binding region (Table 1). Expression of each was tested in P. fluorescens DC454 to assess yield of active protein. Growth of all strains was as expected, reaching OD600 of 30-40, with the exception of DC478 as seen in FIG. 1. The Gal2 mAb expression strain grew poorly, never reaching an OD600 greater than 10 prior to or after induction. Active anti-β-galactosidase antibody derivative was assessed by binding to β-galactosidase using biolayer interferometry. Purified Gal13 scFv and diabody as well as commercially available anti-β-galactosidase mAb were used as control. Gal2 yields using these controls are considered qualitative, as are mAb yields compared to the commercial standard. In a single two-week experiment, relative quantities and activity of eight different antibody derivatives directed toward a single target were established. FIG. 2 shows specific expression of anti-β-galactosidase antibody derivatives. Specific yield for each replicate is shown, expressed as the natural log of the yield (μg/mL) per optical density unit. As shown in FIG. 2, the highest yields of active protein were detected from those strains expressing scFv or Fab derivatives (DC 351, DC596, DC589, DC698 and DC699). No active Gal2 mAb was detected; however, cell densities were very low. Small amounts of active Gal13 mAb and diabody were detected.

### Example 7

### Expression of Anti-Fluorescein Antibody 4-4-20

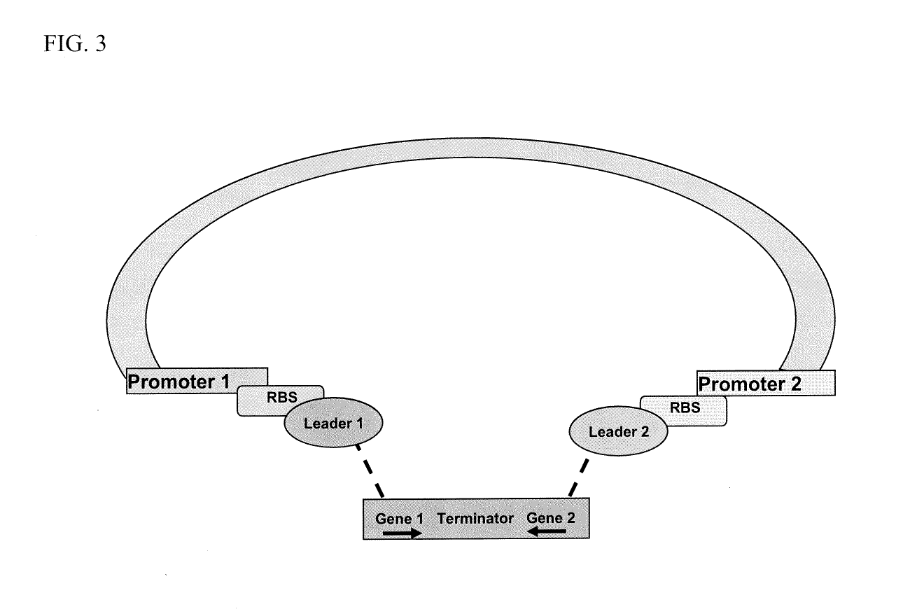

As seen in FIG. 3, a DNA fragment containing the heavy chain (gene 1), bidirectional transcriptional terminator and light chain (gene 2) was cloned into a library of 74 expression vectors with combinations of 2 promoters, 3 ribosome binding sites (RBS) and 3 secretion leaders. The DNA fragment can be cloned in either orientation allowing for 148 possible combinations.

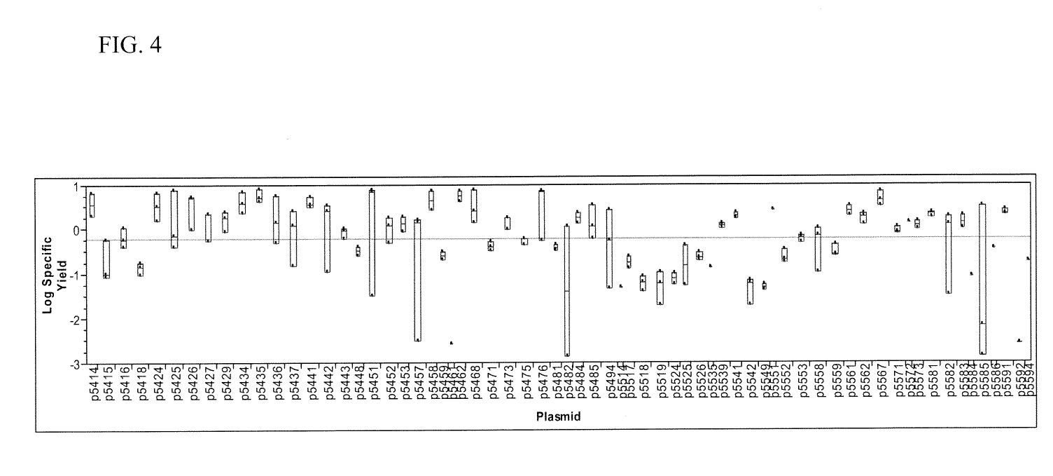

Following ligation of the DNA fragment containing heavy and light chain coding regions separated by a bidirectional transcriptional termination into an arrayed library of 74 expression vectors, as seen in FIG. 3, and electroporation into P. fluorescens, three transformants were selected and anti-fluorescein mAb expression was evaluated. A total of 148 expression vectors could potentially be constructed, taking into account ligation of the DNA fragment in either orientation. Expression was performed in 96 well HTP format as described above, and yield of properly folded mAb was assessed by binding to fluorescein using biolayer interferometry. Within two weeks, the level of mAb expression from 222 transformants of a possible 148 constructs was evaluated. The log transformed specific yield of transformants from each expression vector is shown in FIG. 4. Sequence analysis of plasmids isolated from selected transformants revealed that the DNA fragment did indeed insert in both orientations as expected. Vast differences in the specific expression of transformants resulting from a particular expression vector (e.g., p5451 and p5457) may result from the DNA fragment encoding the heavy and light chains inserting in opposite orientations, thereby altering the promoter and ribosome binding site (RBS) driving expression, as well as the secretion leader directing the protein to the periplasmic space. From the results shown in FIG. 4, it is possible to identify trends and select the optimal promoter, RBS and secretion leader required for each strain to allow the highest amount of active mAb. Further optimization can be achieved by evaluating expression in alternate P. fluorescens host strains as well as varying expression conditions (inducer concentration, temperature, etc.).

The foregoing examples are illustrative of the present invention and are not to be construed as limiting thereof. The invention is defined by the following claims, with equivalents of the claims to be included therein.

What is claimed is:

1. A method for high-throughput screening to simultaneously identify a fused binding domain that has a structure able to bind a selected target, and an expression plasmid therefor, or host cell therefor, the method comprising:
fusing a nucleic acid sequence encoding a binding domain that interacts with the selected target, in frame with each of a plurality of nucleic acids, each of the plurality of nucleic acids encoding a different molecule, wherein each molecule is selected from the group of molecules consisting of a scaffold, another binding domain, and a functionalized domain, to make fused binding domains;
cloning each of the fused binding domains into each of a plurality of plasmids, each said plasmid comprising at least one expression signal selected from the group consisting of a transcription signal, a translation signal, and a protein secretion signal;
transforming a host cell with the cloned fused binding domain plasmids;
simultaneously expressing the fused binding domains in the host cell transformants in a high throughput manner; and
screening expressed fused binding domains for antigen-binding activity;
wherein the screening for antigen-binding activity allows identification of a fused binding domain that has a structure able to bind the selected target, and identification of an expression plasmid or host cell therefor.

2. The method according to claim 1, wherein screening expressed fused binding domains comprises identifying a desired level of antigen-binding activity, bioavailability, half-life, reduced immunogenicity in a subject, or a combination thereof.

3. The method according to claim 1, wherein at least one selected molecule is a functionalized domain, and wherein the functionalized domain is selected from the group consisting of at least one of a stability functionalized domain, a solubility functionalized domain, and a combination thereof.

4. (canceled)

5. The method according to claim 1, wherein the at least one binding domain is derived from an antibody-VH region or an antibody-VL region.

6. The method according to claim 1, wherein the binding domain is derived from a non-antibody binding protein of natural or non-natural origin.

7. The method according to claim 1, wherein the binding domain is selected from the group consisting of a fibronectin derivative, adnectin, ankyrin repeat protein, lipocalin, a protein A derivative, a gamma crystalline derivative, a transferrin derivative, and a synthetic peptide with immunoglobulin like folds.

8. The method according to claim 1, wherein the binding domain was identified using a source selected from the group consisting of a randomly generated library, a B-cell screening, a T-cell screening, a sera screening, and combinations thereof.

9. The method according to claim 8, wherein the ability of the binding domain to bind the selected target was identified by bio-panning, panning, and/or display methods.

10. The method according to claim 1 wherein the method is repeated in one or more of its elements.

11. The method according to claim 1, wherein the at least one molecule is a scaffold selected from the group consisting of an antibody constant region, a non-antibody natural or non-natural stabilizing structure, an additional binding domain derived from an antibody, and an additional non-antibody derived binding domain.

12. (canceled)

13. (canceled)

14. The method according to claim 1, wherein the host cell transformants are simultaneously screened in a production strain array for titer and functionality in a high throughput manner in an in vivo or in vitro system.

15. The method according to claim 1 wherein the host cell is a bacterium.

16. The method according to claim 15 wherein the bacterium is selected from the genus Pseudomonas.

17. The method according to claim 16 wherein the bacterium is P. fluorescens.

18. The method according to claim 15, wherein the bacterium has one or more protease genes deleted or overexpresses one or more folding modulator.

19. (canceled)

20. The method according to claim 1 wherein the fused binding domain plasmids express a single binding domain fused to one or more different scaffolds.

21. The method according to claim 1 wherein the fused binding domain plasmids express more than one binding domain, wherein each binding domain is fused to one or more scaffolds.

22. (canceled)

23. The method according to claim 14 wherein the high throughput manner comprises the use of a multi-well plate and/or growth of the production strains in parallel.

24. The method according to claim 1, further comprising:
screening for activity in a high throughput manner.

25. (canceled)

26. The method according to claim 1 further comprising:
screening antibody derivatives, screening libraries of non-natural binding proteins, screening derivatives of non-antibody binding proteins derived from naturally occurring proteins, or a combination thereof.

27. (canceled)

28. (canceled)

29. A method of identifying and expressing an antibody variant that has a structure able to bind a selected target, the method comprising:
identifying a binding region in an antibody;
fusing a coding sequence for the binding region in frame to each of a plurality of coding regions for scaffolds of antibody constant regions to obtain antibody fragment variant coding regions;
cloning each antibody fragment variant coding region into each of a plurality of plasmids, each plasmid comprising at least one expression signal selected from the group consisting of a transcription signal, a translation signal, and a protein secretion signal;
transforming a host cell array comprising at least four different host cells, wherein each host cell is selected from the group consisting of protease knockout hosts, transcriptional/translational regulatory protein knockout hosts, and folding modulator overexpression hosts, with the cloned antibody fragment variant plasmids; and
simultaneously expressing the antibody fragment variant transformants in a high throughput manner; and
screening expressed antibody fragment variants for antigen-binding activity;
wherein the screening for antigen-binding activity allows identification of an antibody fragment variant that has a structure able to bind the selected target, and identification of an expression plasmid or host cell therefor.

30. A method of parallel screening for antibody product candidates, the method comprising:
identifying at least one binding region in an antibody;
fusing in frame a coding sequence for the at least one identified binding region to coding sequences for each of a plurality of antibody constant regions, in parallel, to obtain a plurality of antibody fragment variant coding regions;
cloning each antibody fragment variant coding region into each of a plurality of plasmids, each plasmid comprising at least one expression signal selected from the group consisting of a transcription signal, a translation signal, and a protein secretion signal;
transforming a host cell array comprising at least four different host cells, wherein each host cell is selected from the group consisting of protease knockout hosts, transcriptional/translational regulatory protein knockout hosts, and folding modulator overexpression hosts, with the cloned antibody fragment variant plasmids; and
simultaneously expressing the antibody fragment variant transformants in a high throughput manner; and
screening expressed antibody fragment variants for antigen-binding activity and protein yield;
identifying a plurality of optimal product candidates and production strains in a single screen;
screening the optimal product candidates in an animal model; and
evaluating the optimal product candidates for optimal bioavailability, half life, and reduced immunogenicity to find antibody product candidates.

31. (canceled)

32. (canceled)

33. The method of claim 1, wherein more than one binding domain that interacts with the selected target is screened in parallel.
